(19) United States
(12) Patent Application Publication
(10) Pub. No.: US 2004/0248722 A1
(43) Pub. Date: Dec. 9, 2004

(54) Methods for forming hardened tubes and sheets

(76) Inventors: Chirstopher Mason, London (GB); Martin Arthur Town, London (GB)

Correspondence Address: NIXON & VANDERHYE, PC, 1100 N GLEBE ROAD, 8TH FLOOR, ARLINGTON, VA, 22201-4714, US

(21) Appl. No.: 10/472,884

(22) PCT Filed: Mar. 26, 2002
(86) PCT No.: PCT/GB02/01183

(30) Foreign Application Priority Data
Mar. 26, 2001 (GB) 0107549.8
Aug. 28, 2001 (GB) 0120815.6
Sep. 11, 2001 (GB) 0121995.5

(51) Int. Cl. B31B 1/00

(52) U.S. Cl. 493/480

(57) ABSTRACT

To produce a hardened tube of biocompatible material, a regulator member (318) is moved in contact with a body of hardenable liquid along a conduit (303) so that a thin layer of the liquid is formed, which immediately contacts a hardening fluid to form the hardenable tube. The tube may incorporate viable cells which are then cultured in the conduit (303) to prepare a surgical implant.

### FIELD OF THE INVENTION

This invention relates to the production of hardened material in the form of flat sheet or tube, by hardening of hardenable liquid. The invention is particularly applicable to the production of flexible sheet or tube of biocompatible material, but is not limited to this. The products of the invention are primarily bioactive in nature, i.e. are biocompatible, and may be implantable products or products intended for prolonged contact with mammalian tissue, containing medically active components (bioactives), such as pharmaceutical compounds, other bioactive molecules and living cells. The invention also relates to apparatus for producing such sheet or tube.

### BACKGROUND OF THE INVENTION

There is great demand for the provision of biologically derived body parts (Vacanti and Langer (1999), Lancet 35A, Suppl 1: 32-34) such as blood vessels for use in surgical procedures. Conventionally, in heart bypass surgery, a length of vein is taken from a patient's leg, and grafted into the cardiac circulatory system to provide an alternative circulatory route around a blockage. This vein conduit technique is not available, for example, if the patient has varicose veins, or previous cardiac bypass surgery using the veins. Therefore alternative materials are desirable. One alternative is native artery, but this too is in limited supply.

Synthetic grafts have been made from materials such as Dacron® or Gore-Tex®. However such grafts fail to remain patent when used for vessels with internal bore below about 4 to 6 mm.

Attempts have been made to provide tissue-engineered, biologically derived blood vessels by growing cells on tubular, synthetic biocompatible scaffolds (Nikalason et al (1999), Science 284, 489-493). Scaffold materials are typically plastics materials, especially thermoplastics materials, such as PGA (polyglycolic acid), PLA (polylactic acid), and PLGA (polylactic coglycolic acid), which are formed into tubes by conventional techniques such as melting followed by extrusion or moulding. Because the plastics must be melted before extrusion or moulding, the thermal and/or mechanical stresses are such that there is limited possibility to incorporate biologically active molecules or cells in the structure formed.

It is also known to encapsulate cells in materials such as alginate for implantation into mammals, in order to achieve delivery of therapeutic molecules secreted by the cells to a desired tissue (see Read, T.-A. et al., Nature Biotechnology 19, pages 29-34, and Joki, T. et al., Nature Biotechnology 19, pages 35-39). In this case, cells are typically encapsulated in beads.

### SUMMARY OF THE INVENTION

The object of the invention is to provide new methods of making tubes and sheets of biocompatible or other material, particularly material which has sensitivity to thermal and/or mechanical stress.

Accordingly the present invention provides a method of forming a layer of hardened biocompatible material in the form of sheet or tube comprising the steps of:

providing a body of hardenable liquid in contact with a guide surface for the formation of the layer,

relatively moving a regulator member and said guide surface with a gap between them so that a portion of said body of hardenable liquid is exposed on said guide surface as a layer of predetermined thickness thereon,

causing hardening of the layer of hardenable liquid thus formed, to form the hardened layer on the guide surface, and

if desired, removing the hardened layer from the guide surface.

By ‘hardened material’ is meant a material sufficiently hard to retain its wall thickness. Sheets and tubes formed according to the present invention will typically be deformable, i.e. flexible or non-rigid. Thus the term ‘hardened material’ is used to encompass porous materials, matrices, solid materials having a high liquid content such as hydrogels, and readily deformable and flexible materials. However the formation of more rigid structures is also contemplated.

The hardenable liquid contains a component capable of being hardened into a hardened layer by any appropriate means, e.g. by physical means, such as cooling or drying, or by chemical means. In one embodiment, the layer of hardenable material is hardened by contact with a fluid causing hardening thereof e.g. chemical hardening. The fluid causing hardening may be a gas containing a hardening agent for the hardenable liquid, a gas effecting hardening of the hardenable liquid by drying, a liquid comprising a reactive hardening agent, e.g. a cross-linking agent, for the hardenable liquid, or a liquid effecting hardening of the hardenable liquid by solvent extraction.

A suitable catalyst may be included to assist the hardening process, as would be understood by the person skilled in the art.

Thus there is provided a method of forming a layer of hardened material in the form of sheet or tube comprising the steps of:

providing a body of hardenable liquid in contact with a guide surface for the formation of the layer,

relatively moving a regulator member and said guide surface with a gap between them so that a portion of said body of hardenable liquid is exposed on said guide surface as a layer of predetermined thickness thereon,

contacting the layer of hardenable liquid thus formed with a fluid causing hardening thereof to form the hardened layer on the guide surface, and

if desired, removing the hardened layer from the guide surface.

The hardenable liquid may alternatively be hardened by irradiation, for example with infra-red radiation, ultra-violet radiation, or visible light, in order to form bonds (which include but are not limited to covalent, ionic, van der Waals and hydrogen bonds) between molecules within the hardenable liquid, or to remove a solvent from the hardenable liquid.

Alternatively, the hardenable liquid may be hardened by physical methods, for example application of heat, or reduction of the pressure of the surrounding atmosphere, by application of a vacuum to remove a solvent.

A suitable combination of hardenable fluid and hardening means can therefore be chosen depending on the use to which the structure to be formed is to be put, and taking account of constraints imposed by other components to be incorporated within the structure.

When the layer of hardenable liquid is to be hardened by contact with a fluid causing hardening, the layer of hardenable liquid is preferably contacted with the second fluid concomitantly with the relative movement between guide surface and regulator. That is to say, the fluid causing hardening is progressively immediately contacted with the layer of hardenable liquid as the layer is formed by the relative movement of the regulator member and the guide surface.

The fluid causing hardening may be provided in a suitable reservoir. Preferably contact between the second fluid and the layer of first fluid is achieved by coupling a flow of the second fluid to the relative movement between regulator and guide surface.

The guide surface may be a plane surface, for formation of hardened flat sheets. In a preferred embodiment, the guide surface may be an inner surface of a guide tube of any suitable cross section. In a preferred embodiment the guide surface is an internal surface of a hollow cylinder. At least where the guide surface is tubular, the relative movement direction of the guide surface and the regulator member is preferably vertical.

The layer of hardenable liquid should substantially retain its shape on the guide surface during the time required to achieve sufficient hardening, so that the hardened layer has the required shape. The degree to which shape is retained will typically be influenced by factors such as the thickness of the layer, interactions between the hardenable liquid and the guide surface, concentrations of the reactive components of the hardenable liquid and fluid causing hardening, and/or the viscosity of the hardenable liquid.

Where the guide surface is an internal surface of a guide tube, a hardened tube will typically be formed. The guide tube may have any desired cross section. If appropriate, the tube so formed may be slit longitudinally and opened out to form a flat sheet.

When the guide surface is a plane surface, the regulator may be a partition or blade movable relative to the guide surface. The thickness of the sheet obtained can be controlled by setting the separation between regulator and guide surface appropriately.

When the guide surface is the inner surface of a guide tube, the regulator may be, for example, a float or piston disposed within the tube. The wall thickness and contour of the hardened sheet or tube to be formed may be controlled by selecting the dimensions of the regulator and the internal cross section of the guide tube.

In one embodiment, movement of the regulator member is caused by flow of the fluid causing hardening. For example, the regulator member may be driven by flow of the fluid causing hardening by a piston action. In one embodiment the regulator member may be formed of a fluid immiscible with the fluid causing hardening and the hardenable liquid. For example where the fluid causing hardening and the hardenable liquid are aqueous, the regulator member may be a droplet of oil or any other suitable immiscible liquid. Alternatively, the regulator member may be gaseous, for example it may be an air bubble. A regulator member formed from an immiscible liquid or a gas may be introduced into the guide tube ahead of the fluid causing hardening.

In especially effective embodiments of the invention, the position of the regulator member in its travel direction relative to the guide surface during the relative movement is determined by the hardenable liquid and/or a fluid, particularly a liquid, which effects the hardening and is preferably on the other side of the regulator from the hardenable liquid during the movement. Thus the position of the regulator member may be determined in the travel direction only by the liquid or liquids in contact with it. In some embodiments, where the relative movement is vertical and the guide surface is a tube, no lateral constraint is needed, since the regulator member can be self-centering in the tube; in this case there is no mechanical or solid connection to the regulator member, which is freely movable across and along the tube.

By the application of a pressure (positive or negative) to a liquid body, or one of the liquid bodies, contacting the regulator member, there may be established a pressure difference on the two sides of the regulator member causing it to move in the travel direction, in particular to move to the side where the body of hardenable liquid is positioned, thereby leaving a thin layer of the hardening liquid on the guide surface.

Preferably, the resultant hardened material will be a biocompatible material. A biocompatible material is considered to be any material which is not harmful or toxic to living cells or tissue. The material may be inert, or may be degradable by living cells or tissues, for example by enzymes produced by living cells or tissues. The material may be suitable for direct implant to a mammalian body. For example, tubes of collagen have been proposed for use in connecting severed nerve bundles. Alternatively, the biocompatible material may be suitable for use as a scaffold for growth of cells either on or within the material. Suitable materials include biologically derived substances such as alginate, collagen, etc., and synthetic materials such as heat-softening materials or thermoplastics, etc. Preferably these will be inert, or will not give rise to toxic degradation products.

Suitably the hardened material has a matrix structure allowing controlled release of bioactive substances such as pharmaceuticals, hormones, growth factors, cytokines, antibodies, nucleic acids such as DNA, isolated cell organelles such as mitochondria, killed cells, and the like.

Additionally or alternatively, living cells may be encapsulated in the matrix of the hardened material. These cells may be eukaryotic or prokaryotic. In this case the matrix may support exchange of proteins, nutrients, oxygen, secreted molecules and waste products between the cells and medium surrounding the hardened material.

Thus the hardened material may act as a tissue engineering scaffold or substrate, supporting growth of the cells. Structures containing living cells may be cultured in vitro e.g. prior to implantation or other uses, or implanted directly into a patient. When cultured in vitro, the scaffold may be degraded once the cells have formed an integral mass (e.g., cells and extracellular matrix) or body and physical support from the scaffold is no longer required. Degradation may be by auto-degradation, or may be caused by a degradative agent such as an enzyme, which may be added exogenously or produced by the cells within the structure. For example, alginate matrix can be degraded by exposure to sodium ions or by lyases. The hardenable material may be chosen appropriately, depending on the intended use, e.g. whether the scaffold is to be degraded prior to implantation or not.

Suitable combinations of hardenable liquids and hardening agents are well known in the art. For example, alginate, e.g. sodium alginate, can be cross-linked by calcium ions into a suitable biocompatible material. Accordingly, the hardenable liquid may contain sodium alginate, and be hardened by contact with a solution containing a calcium salt, such as calcium chloride, as a hardening agent. Cyanoacrylate polymers can be hardened by irradiation with UV light. Other possible combinations of components are well known to those skilled in the art. Examples include:

Acid soluble collagen (liquid) which crosslinks to form a hydrogel when exposed to sodium hydroxide solution;

Fibronectin/fibrinogen (mixture) dissolved in urea which forms a solid when exposed to a solution of hydrochloric acid/calcium chloride;

PLA (poly (L-lactic acid))/chloroform solution, which forms a solid PLA structure when the chloroform evaporates.

The guide surface itself may form part of the final structure. For example the guide surface may be made of PGA, thereby resulting in a multilayered structure, the outer layer of which is formed by the guide surface PGA and the inner layer of which is formed by the hardenable liquid.

The hardenable liquid may contain one or more biologically active agents (bioactives). These active agents may be active molecules, such as pharmaceutical compounds having therapeutic or prophylactic effect, enzymes, growth factors, hormones, cytokines, antibodies, nucleic acids, killed cells, isolated cellular organelles, etc. Additionally or alternatively the biologically active agents may be live cells. If the hardened sheet of biocompatible material is required to contain a uniform distribution of a biologically active agent, then the active agent may be homogenously mixed into the first fluid, consequently being uniformly distributed through the structure of the resultant hardened sheet. Thus the present invention provides a method wherein the first fluid comprises a biologically active agent.

The alginate or other hardening material in the hardenable liquid may be suitably modified to be more compatible with bioactive species included in it. For example, for compatibility with cells, a peptide may be covalently bonded to the alginate, as discussed in Rowley J A, Madlambayan G. Mooney D J. Alginate hydrogels as synthetic extracellular matrix materials. Biomaterials. 20(1):45-53, January 1999.

The hardenable liquid may further comprise one or more discrete layers of different solutions, in order to provide a sheet with substantially distinct layers of active components therein. Each layer may comprise one or more active agents.

In a further embodiment, a biologically active component may be introduced into the fluid causing hardening. This may provide a density gradient of the active component across the sheet. Thus the present invention provides a method wherein the second fluid comprises a biologically active agent.

Sheets and tubes formed according to the present invention have numerous potential applications. For example, a hardened tube may be formed containing a uniform distribution of cells, for example smooth muscle cells. Such a tube may be used as a scaffold for building a blood vessel, e.g. when implanted in a living mammalian body. Endothelial cells may be seeded on the inner surface of the tube and fibroblasts seeded on the outside, to mimic the three-layer structure of a blood vessel.

Alternatively, a hardened tube may be formed having an internal layer of smooth muscle cells, and an external layer of fibroblasts within the matrix. This removes the need to seed fibroblasts on the exterior of a tube containing only smooth muscle cells.

Sheets provided according to the present invention may be used in a wide variety of ways. For example, they may be used as membranes containing active agents for use in therapeutic devices such as transdermal delivery patches. Alternatively they may be used to form tissue grafts, such as tissue engineered skin.

Sheets with biocompatible support matrix may also be used as internal grafts for delivery of any appropriate active substance directly to an internal organ, or to a disease or wound site. For example, a sheet containing wound healing-promoting factors, such as pro-angiogenic factors, may be applied to a section of tissue, such as bowel, to promote knitting together of tissue (e.g., surgical anastomosis) after surgery. Alternatively, pro-angiogenic factors could be delivered to the heart, or anti-angiogenic factors to a tumour in this way.

Other uses include incorporation into bioreactors, or use in implants (e.g., hormonal or contraceptive implants, or in extra-corporal devices (e.g., liver assist devices), e.g., to assist bodily functions during illness.

A further possible use of a tube formed by the invention containing living cells is as a test environment for testing of biologically active compounds such as pharmaceuticals. For example a tube may mimic a blood vessel. One embodiment of the invention is therefore an array of tubes formed by the invention containing living cells and the use of such an array in testing of compounds for biological activity. Such an array may be provided in a so-called well plate, and may be made by simultaneous or sequential production of the tubes in situ in the walls of the method of the invention.

In a preferred embodiment, the guide surface itself serves as a bioreactor after formation of the hardened layer, allowing culture medium to be supplied to the hardened layer without the hardened layer first being removed from the guide surface. A bioreactor typically comprises a chamber containing a culture of cells to which a flow of culture medium is supplied. The flow of medium may for example be continuous or intermittent. Preferably when the guide surface is used as a bioreactor, the hardened layer is enclosed such that sterility of the hardened layer is maintained. Accordingly the methods of the present invention may comprise the further step of providing cell culture medium to the hardened layer in situ on the guide surface. In a preferred embodiment, a flow of cell culture medium is provided across one or more surfaces of the hardened layer.

In a further aspect, the present invention further provides a bioreactor containing a layer of hardened biocompatible material in the form of sheet or tube formed in situ on an internal guide surface thereof. The internal guide surface of the bioreactor will typically be an internal surface of a tube of any suitable cross sectional shape, in order that the hardened layer is enclosed such that sterility of the hardened layer is maintained. The hardened layer need not extend around the full circumference of the guide surface.

The bioreactor may comprise one or more fluid inlets or outlets for supply of culture medium to the hardened sheet or tube. In a preferred embodiment the bioreactor can support a flow of culture medium along the full length of the hardened layer.

The hardened layer within the bioreactor will typically be hardened by chemical reaction. The hardened layer may comprise a bioactive agent within the matrix or on its surface. Thus the hardened layer may be formed with a bioactive agent requiring culture distributed within the matrix. Additionally or alternatively, bioactive agents may be seeded into or onto the hardened layer during culture.

The present invention further provides apparatus for forming a hardened layer of material in the form of sheet or tube by contact between a hardenable liquid and a hardening fluid, comprising a guide tube with a first fluid inlet at a first end thereof defining a sealing surface, and a regulator element locatable within and movable along the guide tube with a gap between the regulator element and the inner surface of the guide tube, the regulator element being adapted to seal against the first fluid inlet at the sealing surface in a loading position, wherein, in use, flow of a fluid through the first fluid inlet causes movement of the regulator element along the guide tube from the loading position.

In this apparatus, the body of hardenable liquid is introduced into the guide tube to form a body above and optionally around the regulator element. The fluid causing hardening is introduced into the guide tube via the first fluid inlet, located below the surface of the hardenable liquid.

In the loading position, the regulator element seals against the sealing surface of the first fluid inlet. By this is meant that the regulator element prevents contact between the hardenable liquid within the guide tube and the fluid causing hardening within the first fluid inlet. This should not be taken to imply any particular interaction between the sealing surface and the regulator element. For example, the regulator element may seat within or around the mouth of the first fluid inlet. Alternatively an air gap may be maintained between the regulator element and the sealing surface, such that the air serves to exclude the hardenable fluid from the first fluid inlet. The regulator element cooperates with the first fluid inlet to prevent contact between the hardenable liquid and the fluid causing hardening in the loading position.

Once a hardened layer of material has been formed, unreacted reagents may be removed from the guide tube via the first fluid inlet. However, in a preferred embodiment, the guide tube has one or more fluid outlets remote from the first fluid inlet for efflux of unreacted reagents.

The hardenable liquid may be introduced to the guide tube via the one or more fluid outlets. Alternatively, the apparatus may comprise a second fluid inlet at the first end of the guide tube for introduction of the hardenable liquid to the guide tube. The first fluid inlet may be disposed within the second fluid inlet, for example coaxially with the second fluid inlet.

The apparatus may further comprise further fluid inlets at the first end of the guide tube.

It may be desirable that once a hardened tube has been formed within the guide tube, the regulator element can be removed from the guide tube, or retained in such a position as not to interfere with further liquid flow along the guide tube. Thus in a preferred embodiment, the apparatus comprises means for retaining the regulator element at a position remote from the first fluid inlet.

Tubes of biocompatible material for use as tissue engineering scaffolds or supports for cell growth are inevitably difficult to connect to a supply of reagents and culture medium. The tubes, and any components contained within them or distributed on the surface, may be delicate and sensitive to handling. Thus handling has the potential to damage the tubes themselves or the cells to be cultured. Furthermore, handling increases the risk of contamination where the tubes must be kept sterile. The present methods and apparatus provide means for forming biocompatible tubes integrally with access tubes adapted to provide fluid flow into or out of the biocompatible tube. This significantly reduces the dangers from unnecessary handling of the hardened tubes.

Accordingly, in a further aspect, the present invention provides a tube assembly comprising a first tube of hardened biocompatible material and a second tube of different material for fluid flow into or out of the first tube, the first tube being in situ formed in contact with the second tube.

The first tube may be chemically hardened as previously described. In a preferred embodiment the first tube is moulded around the second tube. The first tube may have an end portion thicker than its walls. The first tube may be formed on a guide surface of a support member, which may be a tube or mandrel. Accordingly, the first tube may be formed by the methods of the present invention, or by other methods such as extrusion techniques. In a preferred embodiment, the first tube contains a bioactive agent distributed within the biocompatible material. The bioactive agent may be of any of the types described above.

The present invention further provides a biocompatible material having a second tube of different material for fluid flow into or out of the first tube, the method comprising the steps of forming a tube from a hardenable biocompatible material, contacting said hardenable material with a second tube of a different material, and causing hardening of the hardenable material, such that the second tube provides a passage for fluid flow into or out of the first tube.

The biocompatible material may be hardened by any appropriate means, e.g. by physical means such as cooling or drying, or by chemical means. Frequently, the biocompatible material will be hardened by chemical means, e.g. by contact with a fluid causing hardening thereof.

In a preferred embodiment, the first tube is hardened around a portion of the second tube. In one embodiment, the fluid causing hardening is delivered to the hardenable biocompatible material via the second tube. In this case the apparatus used to form the second tube is typically well adapted to form a bioreactor for culture of a bioactive agent contained by the biocompatible material.

### BRIEF INTRODUCTION OF THE DRAWINGS

Specific embodiments of the present invention will now be described by way of example, with reference to the accompanying drawings, in which:

FIGS. 1 and 2 show apparatus for forming a tube according to the present invention.

FIGS. 3 and 4 show the formation of a hardened alginate tube.

FIG. 5 illustrates apparatus for forming a flat sheet according to the present invention.

FIGS. 6 and 7 show the formation of a flat sheet of hardened alginate.

FIGS. 8, 9 and 10 show particular embodiments of apparatus for forming a hardened tube according to the present invention.

FIGS. 11, 12, 13 and 14 show port assemblies of apparatus for forming hardened tubes according to the present invention.

FIGS. 15 and 16 are a cross-sectional view of another device according to the invention for use in making a tube containing living cells, showing two stages in operation of the device.

FIG. 17 is a perspective view of two body parts of the device of FIGS. 15 and 16 in their disconnected state.

FIG. 18 is a sectional view corresponding to FIGS. 15 and 16 showing a maintenance stage of a tube containing living cells in the device.

FIG. 19 is an enlarged axial sectional view of a component of the device of FIGS. 15 and 16.

### DESCRIPTION OF THE PREFERRED EMBODIMENTS

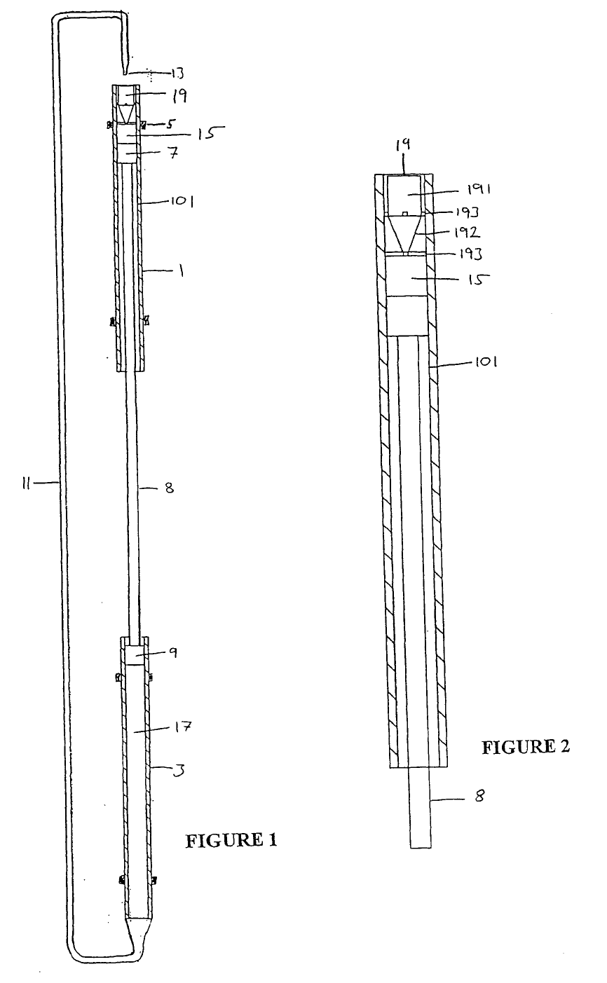

Apparatus for forming a thin-walled tube according to the present invention is illustrated in FIG. 1. An upper cylinder 1 and a lower cylinder 3 are attached by sprung clips 5 to an upright support (not shown). A first piston 7 disposed within upper cylinder 1 forms a sealing contact with the inner side wall 101 of upper cylinder 1, and is connected by means of a common piston rod 8 to a second piston 9 disposed sealingly in the lower cylinder 3. The bottom of lower cylinder 3 opens into tubing 11, which extends up to an outlet nozzle 13 directed downwardly into the open top of upper cylinder 1.

Upper cylinder 1 contains a solution 15 of sodium alginate (2% w/v in deionised water) above piston 7. Lower cylinder 3 contains a solution 17 of calcium chloride (2% w/v in deionised water) below piston 9. Tubing 11 is also filled with calcium chloride solution. A float 19 is located floating in the top of alginate solution 15. This is shown in more detail in FIG. 2.

The float 19 has a cylindrical head 191, whose diameter is 1 mm less than the internal bore of upper cylinder 1. The surface level of the body of solution 15 is near the top of the cylindrical head 191. A tail portion 192 extends downwards from the head 191, and stabilising arms 193 extend horizontally outwards to the inner wall 101 of cylinder 1 from the end of the tail 192 and from the base of the head 191. The stabilising arms 193 centre the head 191 of float 19 within the bore of the upper cylinder before operation begins.

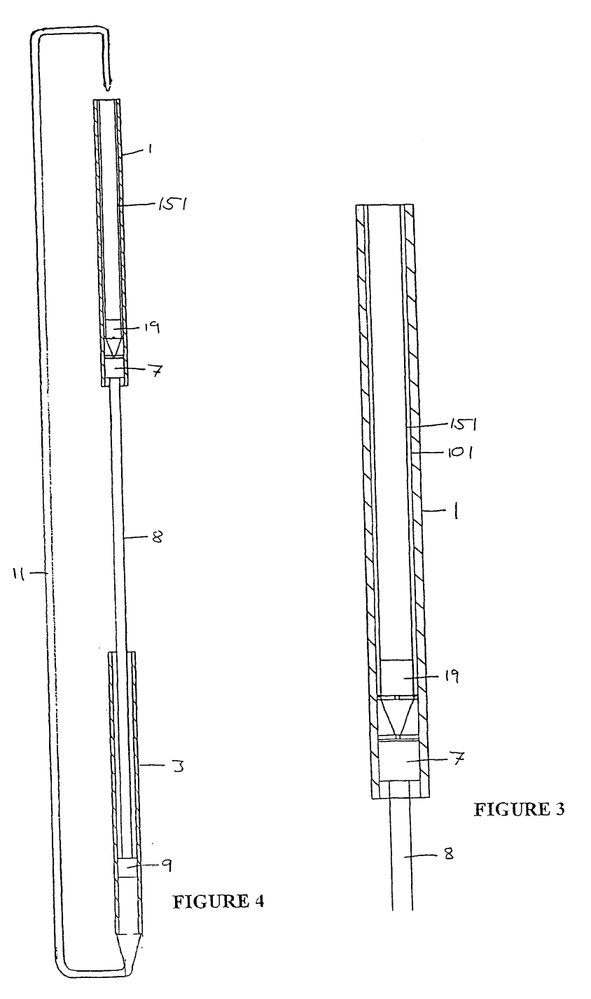

In operation, the piston rod 8 is driven downwardly by a mechanical device (not shown), causing pistons 7 and 9 to move downwardly in their respective cylinders. As piston 7 descends, the bulk of alginate solution 15 below the float 19 also falls, causing float 19 to move down within the cylinder 1. Though the exact forces applying are not clearly analysable, it may be that reduced pressure in the liquid 15 acts to pull the float 19 down. Because the head 191 of the float is narrower than the internal bore of upper cylinder 1, a portion of alginate solution 15 remains in contact with the internal wall 101 of upper cylinder 1, leaving a layer of alginate 151 0.5 mm in thickness on the internal wall 11 of cylinder 1 as float 19 is drawn downwardly. This is illustrated in FIGS. 3 and 4. Tubes with different wall thickness can be easily formed, simply by altering the relative dimensions of the float and the internal bore of cylinder 1. The concentration of alginate may also affect the thickness of the hardened tube.

As the level of alginate solution 15 and float 19 fall in the upper cylinder, calcium chloride solution is pumped into the top of upper cylinder 1 through nozzle 13. Thus the space above float 19 in upper cylinder 1 is immediately filled with calcium chloride solution, which reacts with the layer 151 of alginate, causing it to harden. The calcium chloride solution also supports the layer 151, in part preventing it from falling away from the inner wall 101 of cylinder 1 and collapsing in on itself.

The action of driving the piston rod 8 downwardly causes a thin layer of alginate 151 to be exposed on the internal wall 101 of the cylinder 1, which is simultaneously hardened by the calcium chloride solution pumped into the top of cylinder 1. The alginate layer shrinks slightly on hardening and so becomes detached from the cylinder wall 101. Thus after a suitable setting time, typically around 10 minutes, the hardened tube can be retrieved by simply detaching the upper cylinder 1 from its support, and pouring its contents into a suitable receptacle.

By including suitable components in the alginate and/or calcium chloride solutions, the tube so produced can contain any required biologically active agent distributed within the alginate matrix. There is no need to melt any of the components of the system, so that the entire procedure can be carried out at temperatures appropriate for handling biological molecules and cells Thus temperature-sensitive biological agents such as enzymes, growth factors, cytokines, antibodies etc. can be incorporated into the resultant hardened tube. Because of the very low shear forces involved, cells can also be included in the alginate solution or in the hardening calcium chloride solution, and will remain viable/intact through the tube-forming procedure.

The internal contour of the tube so produced may be varied by altering the shape of the head of the float 19. For example, longitudinal ribs may be formed inside the tube by use of a float with grooves formed in the side of the head. These ribs may impart mechanical strength to the tube. Alternatively or additionally the wall shape of the cylinder 1 may be varied to produce a desired shape, e.g. to increase the surface area of the tube formed.

The concentration of any given active agent can be made to vary across the radius of the tube. For example, the body of the liquid ls shown in FIGS. 1 and 2 may be made up of two distinct solutions layered one on top of the other, with the float 19 inserted at the top. It is not necessary that the two layers are immiscible, provided that they are mainly or partly unmixed at the time of formation of the tube. The hardened tube formed from these components will typically comprise an upper portion derived solely from the upper solution, and a lower portion derived solely from the lower solution, separated by a central portion comprised of substantially distinct inner and outer layers, each layer principally derived from one of the solutions.

Thus, for example, by layering an alginate solution containing smooth muscle cells onto an alginate solution containing fibroblasts in cylinder 1, a tube of alginate matrix can be formed having a portion with an inner layer of smooth muscle cells and an outer layer of fibroblasts. Tubes having portions comprising more than two distinct layers can be formed by layering the required number of solutions on top of one another within cylinder 1. Thus it is also possible to provide a tube with a portion having an inner layer of endothelial cells, a middle layer of smooth muscle cells and an outer layer of fibroblasts. Thus the multi-layered form of physiological structures such as blood vessels can be mimicked. It will be apparent that any active agents can be formed into layers by means of this technique. Alternatively or additionally, layers of different agents may be separated by buffer layers containing no active agent.

Alternatively, a bioactive agent may be included in the second fluid. For example, the second fluid may be an isotonic calcium solution, e.g., calcium chloride, containing cells. In this case, a tube will be formed having a density gradient of these cells radially across the wall of the tube, the density being highest at the inner surface, and decreasing towards the outer surface. The rate of change of the gradient may be controlled by altering factors such as the viscosity of the alginate solution or concentration of calcium chloride solution.

It will be readily apparent that only relative movement between the float and the cylinder is required for operation of the apparatus. Thus other configurations are possible for apparatus within the scope of the present invention. For example, pistons may be held stationary while cylinder bodies are driven upwardly. This will also achieve the effect of drawing a layer of alginate upwardly past the float 19.

The movable portions, be they pistons, cylinders or both, need not be coupled by means of a common rod as shown in FIG. 1, but may be coupled by means of any suitable mechanical linkage. Alternatively, they may be connected to individual control mechanisms and their movement synchronised by a suitable data processor or the like.

In order to make the apparatus more compact, the vertical cylinders 1 and 3 may be disposed side by side, rather than one above the other as in FIG. 1. Thus in a further example the two cylinders 1 and 3 are positioned adjacent to one another, with the orientation of cylinder 3 inverted relative to the configuration shown in FIG. 1. That is to say, piston 9 is located below the calcium chloride solution 17, with tubing 11 running from the top of cylinder 3 to the top of cylinder 1. In operation, cylinder 1 and piston 9 are held stationary, while cylinder 3 and piston 7 are driven downwardly. Thus the apparatus achieves the same effect as that illustrated in FIG. 1, but is significantly more compact.

An arrangement of this type may be required in order to work in an enclosed space, such as a tissue culture cabinet. The present methods will necessarily be performed under sterile conditions when biological material is to be incorporated into the structures formed, or when the structures are intended for implantation into a patient. When sterility is required, it will be apparent that the apparatus used can be adapted accordingly, for example by closing the top of cylinder 1 with a cap having an aperture to accommodate tubing 11.

In an alternative embodiment, piston 7 does not form a sealing contact with the inner wall of the upper cylinder 1. In this case, the alginate solution 15 is introduced into upper cylinder 1 below piston 7. An overflow reservoir is provided from the bottom of cylinder 1. Movement of the piston 7 downwardly within cylinder 1 pushes the alginate solution 15 into the overflow reservoir. Because there is a space between the sides of piston 7 and the inner surface 101 of cylinder 1, a layer 151 of alginate remains on the wall of the cylinder 1 as in the previously described embodiment. Because the alginate moves between the cylinder 1 and the overflow reservoir, the pressure within the bulk alginate solution is not much increased, and so the layer 151 of alginate to be hardened is not extruded past piston 7 under pressure, but is simply left on the wall 151 of the cylinder 1 as the bulk of the liquid moves between cylinder and reservoir.

Thus in this system, the float 19 is not required; its role is performed by the piston 7. As in the previous embodiment, the two pistons 7 and 9 are coupled by the common piston rod 8, and so, as before, calcium chloride solution is pumped into the upper cylinder at the same time as the alginate solution is forced past the piston.

In another example, instead of providing the lower piston 9, lower cylinder 3 and tubing 11 to pump calcium chloride solution into upper cylinder 1, a reservoir of calcium chloride solution is connected directly to the top of cylinder 1 via a pressure-actuated valve mechanism. Downward movement of the piston 7 within cylinder 1 causes a pressure drop within cylinder 1 above the body 15 of alginate solution, causing the valve to open and allowing calcium chloride solution to be drawn into cylinder 1.

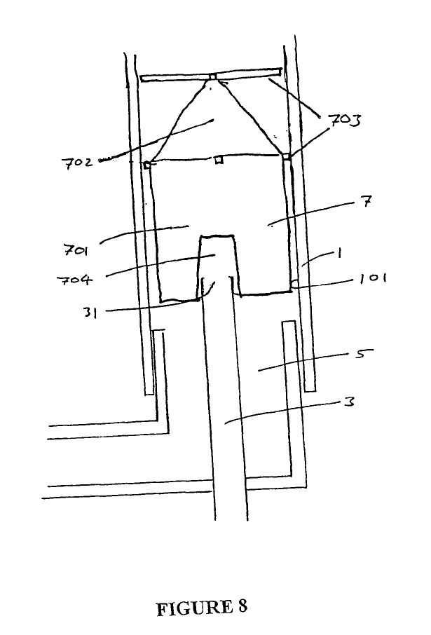

Alternative embodiments of the present invention are shown in FIGS. 8, 9 and 10. FIG. 8 shows an inlet port assembly of apparatus for forming a hardened tube according to the present invention. Guide cylinder 1 of internal bore 4 mm has coaxial inner and outer inlet conduits 3 and 5 respectively. The inner conduit 3 extends into the bore of cylinder 1 from a syringe (not shown) loaded with calcium chloride solution (2% w/v in deionised water).

In order to form a hardened tube of sodium alginate, air is first eliminated from the inner conduit 3 by charging the conduit with calcium chloride solution from the syringe. A slider element 7, acting as a regulator member in the tube forming, is then seated over the mouth 31 of inner inlet conduit 3 in the loading position shown in FIG. 8.

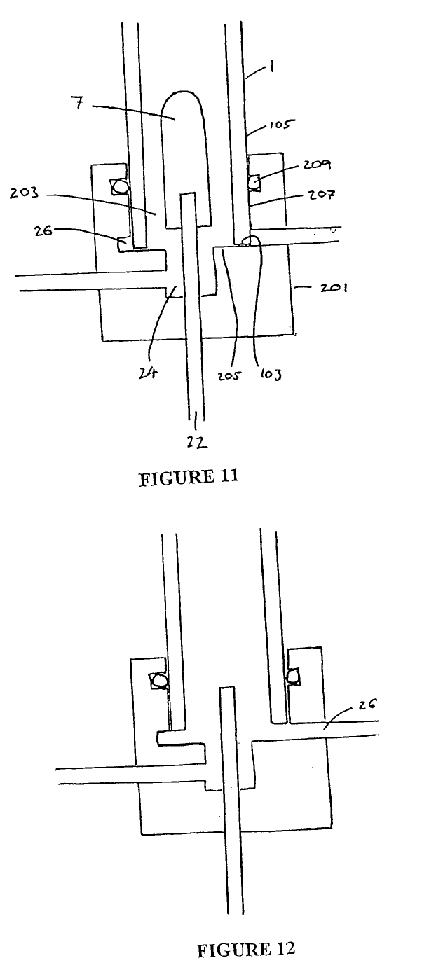

The slider element 7, formed from polytetrafluoroethylene (PTFE), has a cylindrical head portion 701 of diameter 3 mm. A tail portion 702 extends upwardly from head portion 701, and stabilising arms 703 extend horizontally to the inner wall 101 of the cylinder 1 to centre the head portion within the bore of cylinder 1. However, the slider element may be of any suitable shape, and many possible alternatives will be apparent to the skilled person. In one embodiment a bullet shaped slider element, without means for locating against the side walls of the cylinder 1, is used as shown in FIG. 11. The mouth 31 of inner inlet conduit 3 is received by a complementary cylindrical blind bore 704, extending into the lower surface of the head 701. Any air bubble formed as the slider is located over the tip 31 is also accommodated within blind bore 704.

Sodium alginate solution (2% w/v in deionised water) is then fed into cylinder 1 through outer inlet conduit 5. The alginate solution passes between inner wall 101 of cylinder 1 and head 701 of slider element 7, to form a body of liquid above slider element 7. Slider element 7 acts as a seal over inner conduit 3 to prevent contact between the alginate and calcium chloride solutions.

Calcium chloride solution is then injected into cylinder 1 from the syringe. As the calcium chloride solution is injected, the increased pressure in the liquid below the slider element 7 drives the slider element 7 upwardly into the body of alginate solution by a piston action, pushing the alginate solution up inside cylinder 1.

The thin layer of alginate formed between the head 701 of slider 7 and the inner wall 101 of cylinder 1 remains in contact with inner wall 101 as slider 7 rises. This continuous tubular layer of alginate is immediately exposed to the calcium chloride solution beneath slider 7, and is hardened by reaction with the calcium ions. Thus as slider 7 is pushed up inside cylinder 101 by the injection of calcium chloride solution, a progressively longer tube of alginate is formed on the inner wall 101 of cylinder 1.

It is typically desirable to remove the slider element and unreacted reagents from the cylinder after formation of the hardened layer. The upper end of cylinder 1 may be left open, to allow the slider element and unreacted reagents to be removed by pouring, pipetting, etc. Often it is desirable to allow the reagents to remain in contact with one another after tube formation, to allow the tube to set. Typically this takes 10 to 15 minutes at room temperature for an alginate tube formed as described herein. Therefore it may also be desirable to prevent the slider element from falling back down the cylinder after tube formation, as this could damage the alginate layer as it sets. Thus means can be provided to retain the slider at a position remote from the fluid inlets.

For example, in one embodiment, the upper end of cylinder 1 has a tapered neck. The body of the slider element is formed with a complementary taper, so that the slider element becomes lodged in the cylinder neck as it is driven upwards by the flow of calcium chloride solution. The body of the slider may be shaped to protrude from the neck of the cylinder, and be provided with a score line so that the protruding portion can be broken off, leaving a portion of the body having a through bore lodged in the neck of the cylinder. This allows the neck of the cylinder to remain open, providing a conduit for fluid flow into and out of the cylinder.

In an alternative embodiment, the slider element 7 may be omitted, being replaced by an air bubble. This is achieved by leaving a quantity of air in the syringe (not shown) of calcium chloride solution connected to the inner inlet conduit 3. When the calcium chloride solution is injected into the guide cylinder, the air will move or be propelled ahead of it as a bubble, which functions equivalently to the slider element 7. This embodiment is particularly useful for formation of very narrow tubes, e.g. having an external diameter below 1 mm. However, use of an air bubble as a regulator member is not restricted to such small tubes. A further advantage is that the guide cylinder 1 need not have parallel straight sides, as the air bubble can deform to accommodate e.g. constrictions or turns in the guide path. Thus many varieties of shapes of tube, such as helices, angled tubes, or tubes of varying cross section can be formed.

It will be apparent that other fluids can be used in the same way to replace a slider element, as long as they do not mix with either of the other components of the system during operation. For example a droplet of oil, which is immiscible with both the calcium chloride and alginate solutions, and which is of a lower density than the calcium chloride solution, may be used. The particular physical requirements for the fluid will vary depending upon the arrangement of the apparatus used.

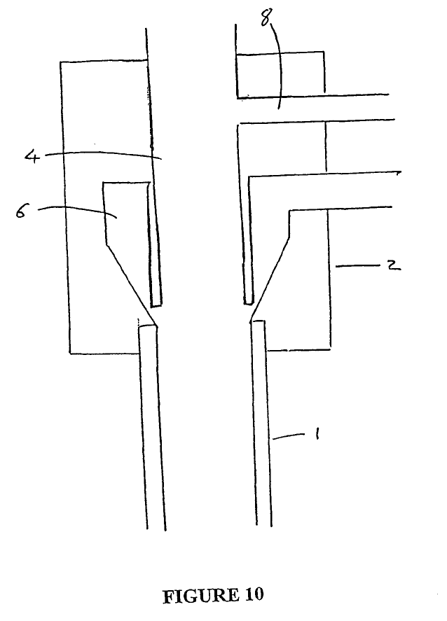

FIG. 10 shows an upper port assembly 2 for cylinder 1, having a central conduit 4, of the same internal diameter as cylinder 1, surrounded by coaxial outer conduit 6 which has an annular opening defined by the mouth of central conduit 4. A branch conduit 8 also feeds into central conduit 4. During formation of an alginate tube, central channel 4 is open, while outlet conduits 6, 8 are sealed. Slider element 7 is driven up into conduit 4 by the flow of calcium chloride solution. Depending on the particular shapes of the slider and the conduit 4, slider 7 may be retained in central conduit 4 above the level of branch conduit 8, or may be expelled entirely from the port assembly 2. Unreacted reagents can be removed from the cylinder via any one of conduits 4, 6 and 8.

When bioactive components such as viable cells are incorporated into the hardened tube, they will normally be mixed with the hardenable liquid before introduction into cylinder 1. In order to ensure optimum mixing, cells etc. may be mixed with the hardenable liquid simultaneously with introduction to the cylinder, e.g. by means of an in-line static flow mixer connected to outer inlet conduit 5. This allows bioactive components to be kept separate from the hardenable liquid until immediately before tube formation.

When cells incorporated into the hardened layer structure require further culture before use, for example to achieve a required cell density, sterility of the structure must be maintained. A particular advantage of the apparatus described herein is that after formation of hardened tube or sheet structures, the guide cylinder itself can form a bioreactor for incubation of the formed structure in culture medium. Culture medium may simply be added to the apparatus before incubation, or alternatively a continuous flow of culture medium may be provided along the cylinder. The ability to culture the structure produced without removing it from the guide cylinder provides substantial benefits in terms of maintaining sterility, and reducing the likelihood of damage to the structure through unnecessary handling.

A continuous flow of medium can be achieved by coupling inlet and outlet conduits to means for supplying a flow of culture medium through the cylinder, such as a peristaltic pump. This can be achieved in numerous ways. For example, the outer conduit 5 of the apparatus shown in FIG. 8 could be manually coupled to such a pump system after formation of the alginate tube, with an appropriate connection at the other end of cylinder 1 for efflux of medium from the cylinder. This coupling procedure will typically be performed under aseptic conditions. The cylinder can then be incubated under appropriate conditions, having controlled temperature, humidity, CO₂ concentration, etc. The cylinder itself may be formed of a gas permeable and/or liquid impermeable material to allow equilibration between the interior of the cylinder and the interior of the incubator.

Alternatively, a valve mechanism may be provided to allow the input to the inlet conduit to be switched successively between two or more fluids such as a tube-forming reagent (e.g. alginate) and culture medium. A three-way valve would allow a washing buffer (e.g. phosphate buffered saline) to wash unreacted reagents from the cylinder prior to addition of culture medium. Suitable assemblies may also be provided at the opposite end of the guide cylinder.

A device of the invention for culturing a hardened tube containing living cells and its use will be described in more detail below.

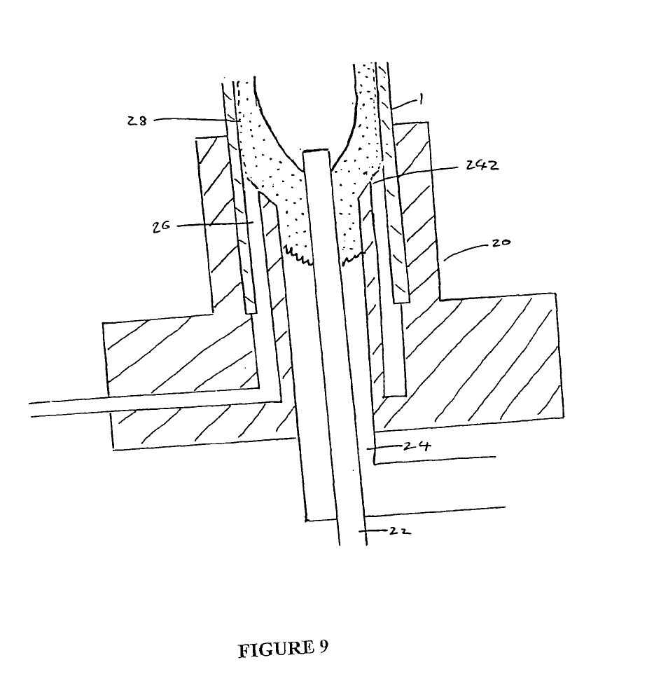

Additionally or alternatively, the inlet and outlet port assemblies may comprise dedicated ports for supply of culture medium. An example of such an inlet assembly is shown in FIG. 9. Certain components of this assembly correspond to those shown in FIG. 8, and so the same numbering will be used for these where appropriate.

The port assembly 20 has three coaxial inlet conduits. Inner and intermediate inlet conduits 22 and 24 correspond respectively to inner and outer inlet conduits 3 and 5 in the assembly of FIG. 8, for supply of reagents. Accordingly, an alginate tube 28 is formed as described above. The shoulders outlet of intermediate conduit 24 are chamfered to direct the hardenable liquid around the slider element 7 (not shown) while loading. Typically, alginate is prevented from passing into outer conduit 26 during loading by filling outer conduit 26 with liquid prior to loading.

As can be seen from FIG. 9, the bottom end of the tube 28 of alginate sets around the inner inlet conduit 22 as it hardens. This is because as the calcium chloride solution fills cylinder 1 below slider element 7, it hardens a portion of the alginate remaining in the mouth of intermediate inlet conduit 24.

The opening of outer conduit 26 is a narrow annulus defined by the shoulders 242 of intermediate conduit 24 and the internal wall 101 of cylinder 1. Flow of culture medium from this conduit therefore eases the hardened tube 28 away from the inner wall 101 of the cylinder, creating a flow path along the outer surface of hardened tube 28. Although the alginate tube 28 is supported on the internal wall 101 by the pressure of liquid within the cylinder, on hardening the alginate tube 28 does not adhere to the wall 101, and may even contract, separating from the cylinder wall 101. This will facilitate the passage of medium between tube 28 and cylinder wall 101. Thus, once the hardened alginate tube 28 is formed within cylinder 1, culture medium may be fed along its bore via inner conduit 22, and between the wall of the tube and the inner wall 101 of cylinder 1 via outer conduit 26.

It is not necessary for both lower and upper port assemblies to possess separate ports for each medium flow. It is possible for the two flows to be recombined before flowing out of the bioreactor through a single port. However if it is necessary to keep the two flows separate then both port assemblies will require a dedicated port for each flow. Thus the inlet port assembly shown in FIG. 9 may be used in conjunction with the upper port assembly of FIG. 10. Here the central channel 8 or intermediate conduit 6 may accommodate flow through the central bore of cylinder 1, while outer conduit 4 accommodates flow between the wall 101 of cylinder 1 and the wall of the hardened tube. Such a construction can also provide bi-directional flow of medium, with the medium outside the hardened tube flowing counter to the medium passing through the tube.

The ability to supply medium to both surfaces of the tube independently provides various advantages. For example, if culture medium were only supplied via the bore of the tube, a gradient of nutrients, etc. would be established across the wall of the tube. By passing medium along both inner and outer surfaces, this problem can be reduced.

Further, different media may be supplied to the inner and outer surfaces of the tube. This may be required where the tube comprises discrete layers, e.g. of different cell types, formed as described. Alternatively, it may assist in construction of a multi-layered tube.

For example, a layered tube may be constructed by forming a hardened tube with one cell type distributed in the matrix. It is then possible to seed a second cell type on the inner or outer surfaces of the tube by flowing an appropriate medium containing that second cell type over the appropriate surface. Thus, the structure of a blood vessel could be mimicked by initially forming an alginate tube containing smooth muscle cells. Endothelial cells can then be seeded on the inside of the tube, and fibroblasts on the outside, by passing appropriate media containing the different cell types over the appropriate surface. A tube having the required three-layered structure can therefore be constructed. Growth of such a construct may be facilitated e.g. by pulsatile flow of medium, to mimic the flow of blood in a developing blood vessel.

A further alternative embodiment is illustrated in FIGS. 11 to 14. As many components of this assembly correspond functionally to those shown in FIGS. 8, 9 and 10 the same numbering will be used where appropriate.

These figures show an arrangement in which the conduit providing flow between the hardened tube and the inner wall of the guide cylinder is closed by the cylinder itself during formation of the hardened tube, and can then be opened by relative movement between the guide cylinder and the upper and lower port assemblies.

FIG. 11 shows a lower port assembly having a block 201 with a cylindrical recess 203 to receive guide cylinder 1. The bottom end 103 of guide cylinder 1 seals against the floor 205 of recess 203. Sealing O-ring 209, recessed into side wall 207 of recess 203 provides sealing contact with outer side wall 105 of cylinder 1. If required, a further O-ring can be provided in floor 205 to seal against bottom 103 of cylinder 1.

Inner inlet conduit 22 extends upwardly into cylindrical recess 203 to engage slider element 7.

Intermediate inlet conduit 24 is coaxial with inner inlet conduit 22 and opens into floor 205 of cylindrical recess 203. Outer inlet conduit 26 is formed by an annular recess in side wall 207. Thus in the closed configuration shown in FIG. 11, outer inlet conduit 26 is sealed by cylinder 1.

FIG. 11 shows a bullet shape of the slider element 7 which acts as the regulator member to form the tube for hardening. It has been found that such an elongate bullet shaped element 7 with a rounded nose maintains the desired central position in the cylinder 1 as it is pushed upwardly, achieving the formation of a tube of uniform wall thickness. The length of the slider member 7 is desirably greater than the diameter of the cylinder 1.

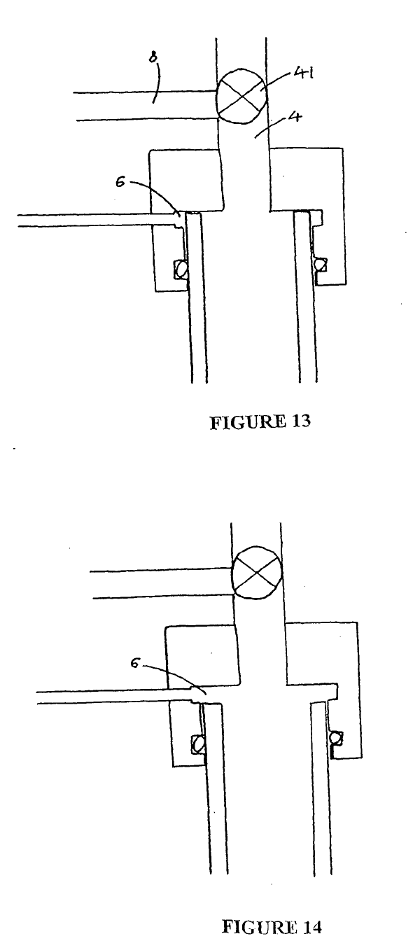

Once a hardened tube has been formed within cylinder 1, outer conduit 26 can be opened by raising cylinder 1 within recess 203, such that the bottom surface 103 of cylinder 1 lies between O-ring 209 and outer conduit 26 as shown in FIG. 12.

This arrangement is mirrored in the upper port assembly illustrated in FIGS. 13 and 14, which show open and closed configurations respectively. Thus it is possible to establish a fluid flow path between outer conduits 6 and 26 after formation of a hardened tube. Outer conduits 6 and 26 may be internally threaded to allow them to be sealed with screw plugs when not required, or before attachment to reagent flow lines.

Central conduit 4 of the upper port assembly is sufficiently wide to accommodate slider element 7, and has a three-way valve 41 located at the junction of central conduit 4 and branch conduit 8. During formation of a tube as described, valve 41 is set so that central conduit 4 is open, forming a path for slider element 7 and unreacted reagents to be removed from the cylinder. After hardening of the tube, the valve is set to open branch conduit 8, forming a flow path for ingress or egress of culture medium or other reagents from the central bore of the hardened tube.

It has been described above that the guide cylinder may form a bioreactor for culture of components seeded in or on a tube (or sheet) formed according to the present invention. It may be necessary for the components of the hardened tube to undergo growth in a radial direction, as well as axially along the tube. Accordingly therefore, the cylinder may be constructed with a removable central portion, removal of which allows radial growth of the tube while leaving the hardened tube supported at both ends.

In order to provide more support for the tube after removal of part of the cylinder, a thin expandable membrane may be provided along the inner surface of the guide cylinder. Thus once an outer portion of the cylinder is removed, the membrane can provide some physical support for the hardened tube as it grows outwardly.

Alternatively, the cylinder may be formed in whole or in part from a suitable stretchable/expandable material to allow for expansion of the hardened tube within it.

A particular advantage of apparatus of this sort is that the bioreactor may serve as a storage chamber for a tissue-engineered construct formed therein once culture is complete. For example, the bioreactor may be isolated from the supply of medium with sufficient fresh medium to sustain the cells in the construct during the storage period. This is particularly advantageous when, for example, a tissue-engineered construct formed in the guide cylinder is to be used for implantation to a patient. The apparatus may be constructed so that the construct can easily be removed from the guide cylinder by a surgeon, allowing the same apparatus to be used to form the tissue-engineered construct, e.g. a length of blood vessel, to culture the construct in situ, and then to store the construct until required and deliver it to the surgeon for implantation. Thus sterility can easily be maintained from creation of the construct scaffold until implantation of the construct to the patient.

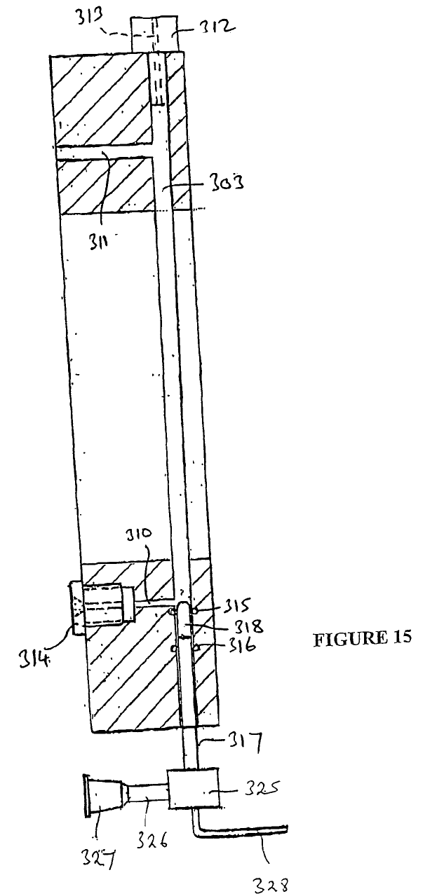

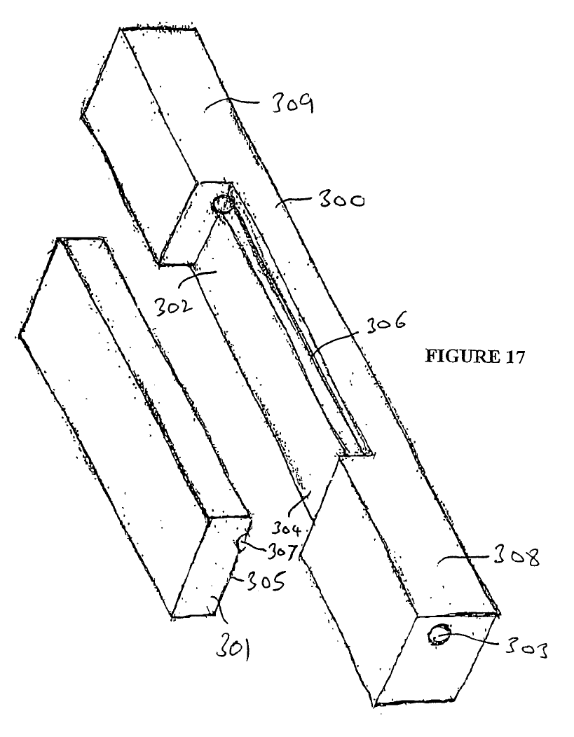

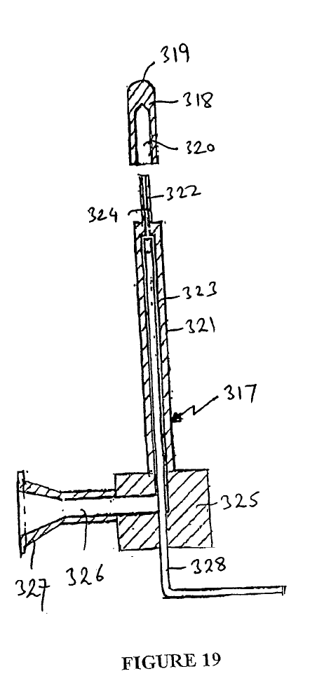

Another embodiment of the invention is shown in FIGS. 15 to 19. The device shown in these figures is particularly suitable for the manufacture under sterile conditions of a tubular implant containing or consisting of living cells, which is intended to be implanted by surgery in a living mammal body, particularly a human. An example of such an implant is a coronary artery bypass graft. A sheet implant can be obtained by cutting a tube, e.g. immediately prior to its use in surgery.

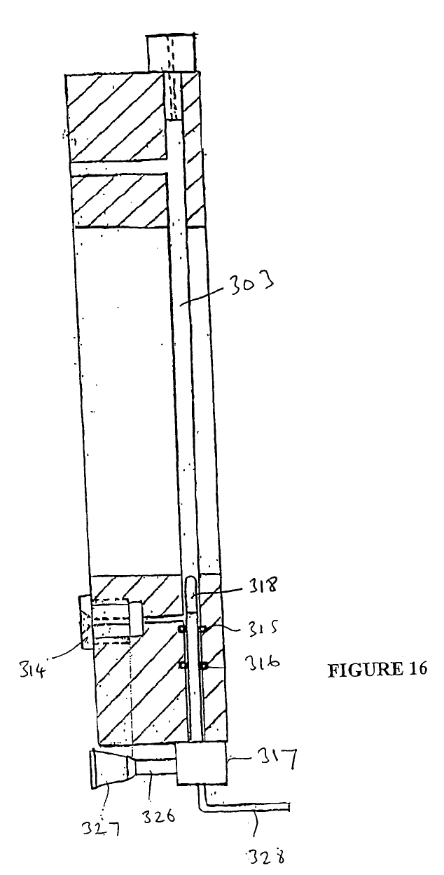

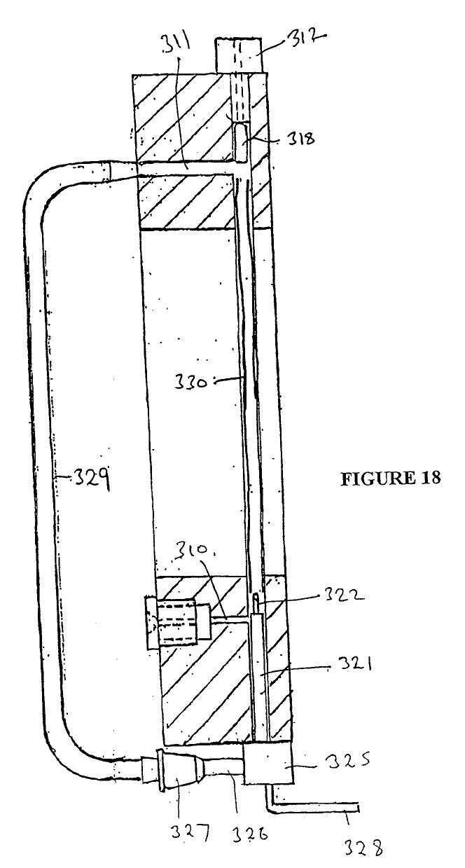

The device illustrated in FIGS. 15 to 19 is formed of components which are all, or mainly, manufactured of injection moulded plastics material, so that it can be made cheaply which is advantageous as it is intended to be used once only. It has a main body of two parts 300, 301 made of synthetic plastics material which is transparent to permit observation of the tube formed in it. The body part 301, which is not seen in FIGS. 16 and 18, fits into a recess 302 of the larger body part 300, and in use is tightly clamped to the part 300 (by suitable clamping means not shown) so that together the body parts 300, 301 define a bore 303 extending between the end faces of the part 300. The base 304 of the recess 302 and the bottom face 305 of the part 301 intercept the axial mid-plane of the bore 303, and each have a groove 306, 307 defining half of the bore 303. When tightly clamped together, the faces 304, 305 meet to seal the bore 303. Seals may be used if needed.

In each of the end portions 308, 309 of the large body part 300, there is a transverse conduit 310, 311 communicating with the bore 303 and extending to a side face of the body part 300. In the upper end of the bore 303 is a plug 312 which is removable and has a bore 313 through it. The lower transverse conduit 310 has a fitting 314 inserted into it to allow injection of liquid. Below the side conduit 310, the bore 303 has two O-rings 315, 316 and receives, as shown in the figures, a removable insert 317 which includes the regulator or slider element 318 which has a cap shape and may be of PTFE, having a rounded leading end 319 and an axial rear recess 320.

The insert 317 has a sleeve portion 321 of the same outside diameter as the regulator member 318 and having a narrow projection 322 at its leading end which in the initial position of the device projects into the recess 320 of the regulator member 318, which thus rests upon the sleeve portion 321. In the sleeve portion 321 is an axial passage 323 which continues into a narrower passage 324 opening at the top end of the narrow portion 322. The axial passage 323 at its lower end passes into a block portion 325 and connects with a transverse conduit 326 leading to a connector 327. Passing into the block portion 325 and extending coaxially almost to the top end of the axial passage 323 is a second inlet conduit 328.

Following manufacture of the components described so ar, the device of FIGS. 15 to 19 is placed in a sterilisable package, of the type used for many surgical devices, which is sealed. Suitable packaging material is Rexam Medical Packaging Integra (Registered Trade Mark) Form medical thermoforming film. The device inside the sealed package may then be sterilised, for example by gamma-radiation, in a known manner. In this form, it is conveniently stored and transported when needed for use to a laboratory for the initial stage of preparation of the implant. This preparation stage typically takes place when a patient is being prepared for surgery using the implant, for example a coronary bypass operation. Cells whose origin is the patient, for example endothelial cells obtained from a skin biopsy on the patient, have been cultured and prepared for incorporation in the implant. Cells of a cell line may be used alternatively, if appropriate.

The tube-forming device at this stage is arranged as in FIG. 15, with bore 303 vertical and the insert 317 in the bore 303 sufficiently far that the regulator member 318 seals to the upper O-ring 315 while the sleeve portion 321 seals to the lower O-ring 316. The regulator member 318 leaves the side passage 310 open. Alginate solution as described above containing cells from the patient is injected via the fitting 314 through the side conduit 310 into the bore 303 in appropriate amount for the formation of the hardened tubular body which is a precursor stage in the formation of the implant. This alginate solution incorporating the cells constitutes the hardenable material of the present invention. The hardening liquid is a calcium chloride solution which is injected into the device through the connector 327, so as to rise up the axial passage 323. Initially, the pressure of this calcium chloride solution is insufficient to lift the regulator member 318, which is held by the O-ring 315, and therefore the solution passes into the conduit 328 and flows out of the device. This action has the effect of flushing air from the insert 317, so that at most only a small amount of air remains in the recess 320 of the regulator member 318.

After the hardenable liquid has been injected through the side conduit 310, the insert 317 is pushed upwardly to the position shown in FIG. 16. The calcium chloride solution is now injected at higher pressure through the conduit 326 to cause the regulator member 318 to lift off the insert 317 and be propelled upwardly along the bore 303 to shape and harden a tube 330 of alginate containing the living cells of the patient, in the manner described above. Thus the regulator member 318 has a diameter less than that of the bore 303 by an amount corresponding to the desired wall thickness of the alginate tube. Air and/or excess liquid may escape via the conduit 311 or 313.

The formed tube 330 is illustrated in FIG. 18, and as indicated, being non-rigid and flexible detaches itself from the wall of the bore 303. FIG. 18 also shows the final position of the regulator member 318 which as shown lodges in the upper end of the bore 303 where it is trapped by appropriate means (not shown) such as a narrowing or an O-ring in the bore. Thus in this embodiment also, the hardening liquid (calcium chloride solution) moves the regulator member 318 along the bore 303 in the body 300, 301 to cause the formation and hardening of the tube 330.

Next follows a stage in which the living cells in the tube 330 are subjected to culturing and growth, while the alginate of the tube 330 may be degraded, e.g. enzymatically, and even vanish, leaving a tubular structure formed of the living cells. The living cells may in this stage produce collagen and elastin, to achieve strength of the tube 330. This stage may last an appropriate number of weeks, for example 6 to 12 weeks, before the tube 330 is ready for implanting in the patient. An external tube 329, made of flexible material connects the side conduit 311 and the connection 327, so that a culture medium for the cells can be circulated continuously over one or both surfaces of the tube 330. A peristaltic pump acting on the tube 329 is suitably employed to effect this circulation. The culture medium may be inserted, drained and replaced via the conduit 328 or via a T-connector or three-way valve included in the circuit (not shown). The whole apparatus is maintained at 37° C. in this stage. Observation of the tube 330 can be made, through the transparent body parts 300, 301. The duration of this stage may be greater than is required for the cell growth and development which forms the tube 330 into a state of readiness for implanting in the patient. The implant 330 can be maintained in its state of readiness for a considerable time, or even subjected to a storage technique.

A further requirement of the storage and cell growth stage is the introduction of oxygen and removal of carbon dioxide. Suitable methods are available for this, and it has been found that a silicone material for the tube 329 provides for this transfer of gases.

When the patient is ready for the implantation operation, the device containing the tube 330 can be taken to the operating theatre with the tube 330 still maintained in a completely isolated state so that undesirable contacts with the tube 330 are avoided. It is then opened, for example by the surgeon, by unclamping and removing the body part 301, this being the first time that the tube 330 is exposed the tube 330 can be lifted out and easily brought to the patient.

After use, the device shown in FIGS. 15 to 19 becomes waste, and is easily disposed of.

A further advantage of the device of FIGS. 15 to 19 and its manner of use described above is that the tube 330, containing the patient's cells, remains in the device from its initial formation in a sterilized device until it is presented to the surgeon for use, which is very advantageous for the marking and tracking of the tube 330. Procedures which involve handling of the implant, which is fragile, and its transfer from apparatus to apparatus create the risks of damage to the tube and of a mistake in its identity.

Many groups have suggested encapsulation of cells in alginate, either for implantation to a patient, or for constructs for use in vivo or ex vivo. While there are various techniques for producing alginate beads containing cells, such beads are extremely fragile and easily damaged on handling. Consequently even transferring beads of encapsulated cells into an appropriate vessel or surrounding membrane is difficult to achieve without substantial damage to the beads, and consequently to the encapsulated cells.

The apparatus of the present invention provide a means to address this problem by formation of such alginate beads within a hardened tube which serves as a protective sheath or surrounding membrane for the beads. This will considerably reduce the subsequent handling required, and consequently reduce damage to the beads.

By way of illustration, a hardened alginate tube may be formed as described on the inner wall 101 of the cylinder having inlet and upper port assemblies as shown in FIGS. 8 and 10. The cylinder is then refilled with calcium chloride solution, leaving a small air gap below the mouth of intermediate conduit 6 of the upper port assembly 2. A suspension of cells in alginate is then delivered dropwise into the calcium chloride via intermediate conduit 6 (or central channel 8). The drops harden to form beads on contact with the calcium chloride solution. Thus alginate beads are formed within a sheath or membrane, without risk of damage to the beads. The entire assembly may then be cultured within the guide cylinder 1 without compromising the sterility or structural integrity of the assembly.

Structures formed in this manner may have a variety of uses, for example as organ assist devices for use ex vivo. The intended use will determine the choice of material for the sheath or membrane, whether or not cells are incorporated into the sheath itself, and also the choice of cells for use in the beads. Thus, for example, a device for liver assist will typically contain encapsulated hepatocytes. Hepatocytes may also be incorporated into the sheath. Where the device is to be used to assist kidney function, for example in kidney dialysis, kidney cells will be encapsulated.

Additionally or alternatively the sheath may contain other factors, such growth factors for the encapsulated cells, or other cell types capable of secreting such stimulatory factors.

Beads containing more than one cell type may be formed within the same sheath. By mixing two or more cell types in an alginate suspension, beads containing a heterogeneous mixture of cells may be formed. Alternatively, by sequential supply of different cell suspensions via the same port, or simultaneous supply of different cell suspensions via different ports, mixtures of beads each containing defined discrete cell populations may be formed.

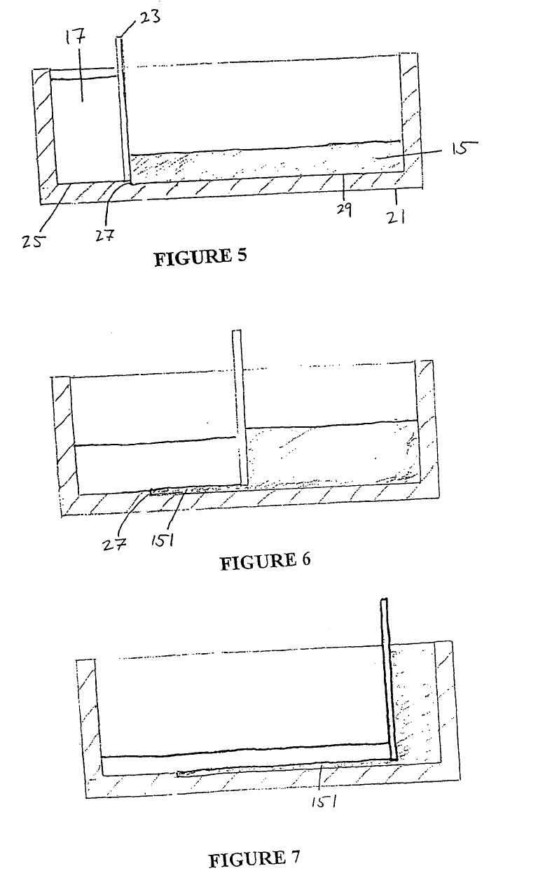

Another embodiment of the present invention, suitable for forming flat sheets, is illustrated in FIGS. 5 to 7. A tank 21 holds an alginate solution 15 and a calcium chloride solution 17 as described above, separated by a movable partition 23. The bottom surface of the tank has an upper surface 25 and a lower surface 29, separated by a step 27. Initially the movable partition is sealingly located on the upper surface 25 at the step 27 as shown in FIG. 5. In operation, the partition 23 is moved horizontally into the body of the alginate solution 15, leaving a layer 151 of alginate extending over the lower surface 29 between the partition 23 and the step 27. The calcium chloride solution 17 will simultaneously flow over the alginate layer 151 as it is exposed by movement of the partition 23. Thus a hardened flat sheet of alginate, the height of the step 27, is formed on the lower surface 29 of the tank 21.

In an alternative embodiment, the bottom of the tank 21 may be flat, without a step 27. Here, the partition is moved upwardly by a required amount before or during its horizontal movement in order to define the leading edge of the alginate sheet to be formed.

Multilayered sheets can be formed by layering different solutions in the tank. Any turbulence caused by the movement of partition 23 will tend to cause the layered solutions to mix. Turbulence may be avoided by regulating the speed of movement of the partition appropriately, and by bevelling the edge of the partition 23 in contact with the solution 15.

The methods described herein lend themselves to construction of structures suitable for implantation into patients during surgery. In particular, as described it may be appropriate to incorporate autologous cells derived from the patient into such structures, in order to prevent immunological rejection. Apparatus used to practise these methods can be tailored to the precise size of implant required, reducing wastage of materials and minimising the quantity of bioactive agent required to construct a suitable implant.

Only simple apparatus is required to put the present invention into practice. Sterile, single-use, disposable apparatus suitable for practising the methods described can be readily produced at low cost. Manipulations of cells and formation of structures according to the present invention can thus be performed under sterile conditions at minimum expense and with minimum risk of contamination. Because of the simplicity of the apparatus required, the methods described herein can easily be automated.

It is a feature of embodiments of the invention that the body of hardenable liquid may be subjected to low shear forces as it is transformed into a thin-wall shape by the relative movement of the guide surface and the regulator member. It has been found that living cells are well able to withstand such forces.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A method of forming a layer of hardened biocompatible material in the form of sheet or tube comprising the steps of:
providing a body of hardenable liquid in contact with a guide surface for the formation of the layer,
relatively moving a regulator member and said guide surface with a gap between them so that a portion of said body of hardenable liquid is exposed on said guide surface as a layer of predetermined thickness thereon,
causing hardening of the layer of hardenable liquid thus formed, to form the hardened layer on the guide surface, and
if desired, removing the hardened layer from the guide surface.

2. A method according to claim 1, wherein the layer of hardenable liquid is caused to harden by contacting the layer of hardenable liquid with a fluid causing hardening thereof.

3. A method of forming a layer of hardened material in the form of sheet or tube comprising the steps of:
providing a body of hardenable liquid in contact with a guide surface for the formation of the layer,
relatively moving a regulator member and said guide surface with a gap between them so that a portion of said body of hardenable liquid is exposed on said guide surface as a layer of predetermined thickness thereon,
causing hardening of the layer of hardenable fluid thus formed by contact with a fluid effecting hardening, to form the hardened layer on the guide surface, and
if desired, removing the hardened layer from the guide surface,
wherein the position of said regulator member in the relative travel direction is determined by one of said body of hardenable liquid and said fluid effecting hardening.

4. A method according to claim 2, wherein the fluid causing hardening is selected from:
a gas containing a hardening agent for the hardenable liquid,
a gas effecting hardening of the hardenable liquid by drying,
a liquid comprising a reactive hardening agent, e.g. a cross-linking agent, for the hardenable liquid, and
a liquid effecting hardening of the hardenable liquid by solvent extraction.

5. A method according to claim 3, wherein the fluid causing hardening is progressively immediately contacted with the layer of hardenable liquid as the layer is formed by the relative movement of the regulator member and the guide surface.

6. A method according to claim 5, wherein the regulator member acts as a barrier separating the fluid causing hardening from said body of the hardenable liquid.

7. A method according to claim 6 wherein the regulator member is driven by the fluid causing hardening.

8. A method according to claim 1, wherein the regulator member is a float floating on the hardenable liquid.

9. A method according to claim 1 wherein the hardening liquid comprises a plurality of discrete bands of different solutions, to form a hardened layer having substantially distinct sub-layers.

10. A method according to claim 3, wherein the hardened material is biocompatible material.

11. A method according to claim 1 or 10 wherein the biocompatible material contains a bioactive agent.

12. A method according to claim 11 wherein the hardenable liquid contains the bioactive agent.

13. A method according to claim 2, wherein the hardened material contains a bioactive agent, and wherein the fluid contains the bioactive agent.

14. A method according to claim 11 wherein the bioactive agent is a bioactive molecule.

15. A method according to claim 11, wherein the bioactive agent is viable cells, killed cells, isolated cellular organelles, a pharmaceutical, an enzyme, a growth factor, a hormone, a cytokine, an antibody or a nucleic acid.

16. A method according to claim 1, further comprising the step of providing cell culture medium to a surface of the hardened layer in situ on the guide surface.

17. A method according to claim 16 wherein a flow of cell culture medium is provided across at least one surface of the hardened layer.

18. A sheet or tube of hardened biocompatible material containing a bioactive agent having a controlled distribution through its wall thickness.

19. A sheet or tube according to claim 18, wherein the bioactive agent has a uniform concentration across its wall thickness or a controlled concentration variation across its wall thickness.

20. A sheet or tube according to claim 18, wherein the bioactive agent is a pharmaceutical to be delivered to a desired site in a living mammal.

21. A sheet or tube according to claim 18 wherein the bioactive material is viable cells, killed cells, isolated cellular organelles, a pharmaceutical, an enzyme, a growth factor, a hormone, a cytokine, an antibody, or a nucleic acid.

22. Apparatus for forming a hardened layer of material in the form of sheet or tube by contact between a hardenable liquid and a hardening fluid,
comprising a guide tube with a first fluid inlet at a first end thereof defining a sealing surface, and a regulator element locatable within and movable along the guide tube with a gap between the regulator element and the inner surface of the guide tube, the regulator element being adapted to seal at the sealing surface in a loading position,
wherein, in use, flow of a fluid through the first fluid inlet causes movement of the regulator element along the guide tube from the loading position.

23. Apparatus according to claim 22, the guide tube having one or more fluid outlets remote from the first fluid inlet.

24. Apparatus according to claim 22, further having a second fluid inlet at the first end of the guide tube.

25. Apparatus according to claim 24, wherein the first fluid inlet is disposed within the second fluid inlet.

26. Apparatus according to claim 22 comprising means for retaining the regulator element at a position remote from the first fluid inlet.

27. A bioreactor containing a layer of hardened biocompatible material in the form of sheet or tube formed in situ on an internal guide surface thereof.

28. A bioreactor according to claim 27, wherein the layer of biocompatible material is hardened by chemical reaction.

29. A bioreactor according to claim 27 comprising a bioactive agent on the surface of or distributed through the hardened layer.

30. A tube assembly comprising a hardened first tube of biocompatible material and a second tube of different material for fluid flow into or out of the first tube, the first tube being in situ formed in contact with the second tube.

31. A tube assembly according to claim 30, wherein the first tube is chemically hardened.

32. A tube assembly according to claim 30, wherein the first tube is moulded around the second tube.

33. A tube assembly according to claim 32 wherein the first tube has an end portion thicker than its walls.

34. A tube assembly according to claim 30, wherein the first tube is formed on a guide surface of a support member, wherein the support member may be a tube or mandrel.

35. A tube assembly according to claim 30 wherein the biocompatible material contains a bioactive agent.

36. A method of forming a tube assembly as described in claim 30 comprising the steps of forming a tube from a hardenable biocompatible material, contacting said hardenable material with a second tube of a different material, and causing hardening of the hardenable material, such that the second tube provides a passage for fluid flow into or out of the first tube.

37. A method according to claim 36, wherein the first tube is hardened around a portion of the second tube.

38. A method according to claim 36, wherein the biocompatible material is hardened by contact with a fluid causing hardening thereof.

39. A method according to claim 38 wherein the fluid causing hardening is delivered to the hardenable biocompatible material via the second tube.

40. Device for use in forming a tube of material for medical use comprising a body defining a guide conduit in which the tube is to be formed and a regulator member adapted to move along the conduit and having a cross-sectional shape such that it leaves a gap between itself and the conduit whereby the tube is formed, said conduit having at least one port for admission of liquid thereto, wherein said body and said regulator member are encapsulated within a sealed enclosure and are in a sterilised state therein.

41. Device according to claim 40, wherein said regulator member has a longitudinal length greater than the largest cross-sectional dimension of said conduit at the zone where the tube is to be formed.

42. Device according to claim 40 including a support for holding the regulator member at a starting position in the conduit.

43. Apparatus for holding a medical construct in the form of a tube comprising living cells, in preparation for use thereof in surgery, comprising a body having a conduit containing said medical construct formed in situ therein and further containing culture medium therefor, and means for passing culture medium through said conduit.

44. Apparatus according to claim 43, wherein said means for circulating culture medium comprises a loop conduit connecting remote ends of said conduit containing said medical construct and a pump for passing culture medium along said loop conduit.

45. Apparatus according to claim 43, comprising means for removing carbon dioxide from said culture medium and/or for adding oxygen thereto.
